(19) United States
(12) Patent Application Publication
(10) Pub. No.: US 2015/0001382 A1
(43) Pub. Date: Jan. 1, 2015

(54) Customizable Slowing Process Using Only Magnetic Fields to Remove Energy from an Atomic or Molecular Beam

(71) Applicant: Government of the United States, as represented by the Secretary of the Air Force, Wright-Patterson AFB, OH (US)

(72) Inventors: Eric A. Imhof, Beavercreek, OH (US); Matthew B. Squires, Sandia Park, NM (US); Spencer E. Olson, Tijeras, NM (US); James A. Stickney, Wakefield, MA (US)

(21) Appl. No.: 14/304,857

(22) Filed: Jun. 13, 2014

Related U.S. Application Data
(60) Provisional application No. 61/834,865, filed on Jun. 13, 2013.

(51) Int. Cl. H05H 3/02

(52) U.S. Cl. CPC H05H 3/02
USPC 250/251

(57) ABSTRACT

Two versions of a new chip-scale apparatus and method for controlling pre-cooled neutral atoms, molecules and other neutral particles are disclosed. The first version sends a beam of neutral atoms between a pair of permanent magnets on either side of a chip-scale apparatus. A plurality of plane parallel wires, or current-carrying conductors, is placed below the beam, each wire perpendicular to the direction of the beam. Currents are sequentially applied to each wire to create a moving magnetic field to sequentially slow the atoms. The second version sends a beam of neutral atoms above a four-wire waveguide. A pair of back and forth plane parallel wires are placed at a lower and a higher level above the beam, the straight portions of each wire alternately crossing above and perpendicular to the beam of neutral atoms. Currents flow through each back and forth wire such that the current in one back and forth wire is out of phase with the other so that a moving magnetic field is formed to control, slow or guide the atoms in the beam.

### CROSS-REFERENCE TO RELATED APPLICATIONS

This application claims the benefit of the filing date of Provisional Application Ser. No. 61/834,865, filed Jun. 13, 2013, titled “Customizable Slowing Process Using Only Magnetic Fields to Remove Energy from an Atomic or Molecular Beam,” and incorporates its contents by reference into this application.

### STATEMENT OF GOVERNMENT INTEREST

The invention described herein can be manufactured and used by or for the U.S. Government for governmental purposes without payment of any royalty.

### BACKGROUND OF THE INVENTION

This invention relates generally to cold neutral atom production by magnetic trapping. More specifically, the invention relates to creating bias-free magnetic traps, including controllable magnetic traps, on a chip, and in a second of two versions, without requiring difficult to implement on and off timing.

Many physical experiments and emerging technologies rely on manipulation of cold; more precisely, slow atoms, and therefore require a source of such slow atoms. Those sources include a magneto-optic trap (MOT), which uses specifically tuned laser light and a static magnetic trap to remove energy from an atomic cloud. Another example source, a Stark Decelerator, uses specifically timed electric potentials to remove energy from an atomic or molecular beam.

Optical and electrical approaches for cooling suffer from many drawbacks. Optical slowing requires specific light frequencies and precise calculation of quantum energy levels of atoms to be cooled. Except for alkali metals, both the frequencies and calculations are difficult to achieve. Also, electric potentials must interact with an electrically charged atom or molecule. Both approaches fail for slowing a broad range of complex, electrically neutral atoms and molecules.

To slow these more complex neutral particles, recent efforts have been made to slow atomic and molecular beams using magnetic fields. These efforts have met challenges as well. Particularly, magnetic interaction is much weaker than optical or electric interactions. Therefore, to remove an appreciable amount of kinetic energy, one must use comparatively large magnetic fields or have a comparatively long interaction time. Both approaches have drawbacks.

Creating large magnetic fields requires high electric currents to produce, creating heat management issues. Long interaction times require a slowing apparatus too large for most applications.

Prior efforts at slowing have used time dependent magnetic fields. For example, imagine an atomic beam oriented on the same axis as a series of solenoids, which all begin in an off position. To begin, a pulse of the atomic beam is released and the first solenoid turned on. When the pulse reaches this first solenoid, it encounters a region of high magnetic potential, and slows. Before the pulse exits the solenoid, the solenoid is turned off and the next solenoid turned on. As the now slower atom pulse reaches the second solenoid, it slows, the solenoid is turned off, the next solenoid turned on, and so on.

The timing of when to turn each solenoid on and off is determined by a so-called “time-of-flight” calculation. “Time-of-flight” means that an “average” atom in the pulse is imagined, and its trajectory mapped as it transits the series of solenoids. The solenoids are then turned on or off to match when this atom has arrived at each stage.

Time-of-Flight (TOF) based slowing is not an optimized slowing apparatus. At each stage, a specific amount of energy is removed, then after some propagation time to the next stage, another specific amount of energy is removed. This piecewise defined slowing can be improved.

Prior art magnetic traps are also often relatively large and cumbersome, preventing their use with modern compact components.

It is clear, therefore, that new approaches for magnetic slowing of atoms, molecules and other particles are needed.

### SUMMARY OF THE INVENTION

The present invention solves the problems of the prior art by two new versions of a compact, chip-scale approach for slowing, controlling and guiding a beam of atoms or molecules using an optimized time dependent magnetic field to slow a broad range of velocities with minimal necessary field strength and interaction time.

The first version directs a beam of neutral atoms across a static magnetic field created by a pair of permanent magnets and generates a moving magnetic field, or trap, with a plurality of wires each carrying a current timed to create a moving magnetic field for slowing the atoms.

The second version directs a beam of neutral atoms over a four-wire waveguide and generates a moving magnetic field, or series of traps, by a pair of back and forth plane parallel wires above the beam, the straight portions of each wire alternately crossing above and perpendicular to the beam. Currents flow back and forth through each wire such that the current in one back and forth wire is out of phase with the other such that a moving magnetic trap is formed to slow, or control, the atoms in the beam.

### BRIEF DESCRIPTION OF THE DRAWINGS

The present invention will become more apparent from the following detailed specification and drawings.

FIG. 1 is a schematic view of a creation of a magnetic field along a current carrying wire, or conductor.

FIG. 2 is a schematic view of a Helmholtz pair configuration of two coils of wire with currents running in opposite directions to produce a zero magnitude magnetic field at their center, with the field increasing in all directions from that point.

FIG. 3 is a schematic view of a two dimensional magnetic trap created by a wire in an imposed bias field.

FIG. 4 is a schematic view of a magnetic trap created by three wires in a sideways H-pattern within an imposed bias field.

FIG. 5 Is a schematic view of a static magnetic field between two permanent magnets.

FIG. 6 is a schematic perspective view of an example embodiment of the first version according to the teachings of the present invention showing a plurality of current carrying wires, or conductors, placed below a static magnetic field created by a pair of permanent magnets mounted on a chip.

FIG. 7 is a schematic view of a four-wire waveguide and resulting magnetic field.

FIG. 8a is an exploded, and FIG. 8b a less exploded, schematic perspective view of an example embodiment of the second version according to the teachings of the present invention showing a pair of back and forth current carrying wires, or conductors, above a four-wire waveguide.

### DETAILED DESCRIPTION

### Magnetic Trapping

A magnetic trap is a point in space where the magnitude of the magnetic field goes reaches a minimum and increases in all directions from that point.

Atoms can be in either a “low-field seeking” or “high-field seeking” state, meaning they either travel towards minima in the magnetic field or maxima. We cannot capture the high-field seeking atoms (it is impossible to create a maximum in the magnetic field). However, we can create a minimum, a magnetic trap, to capture low-field seeking atoms.

### Creating a Magnetic Trap in Free-Space

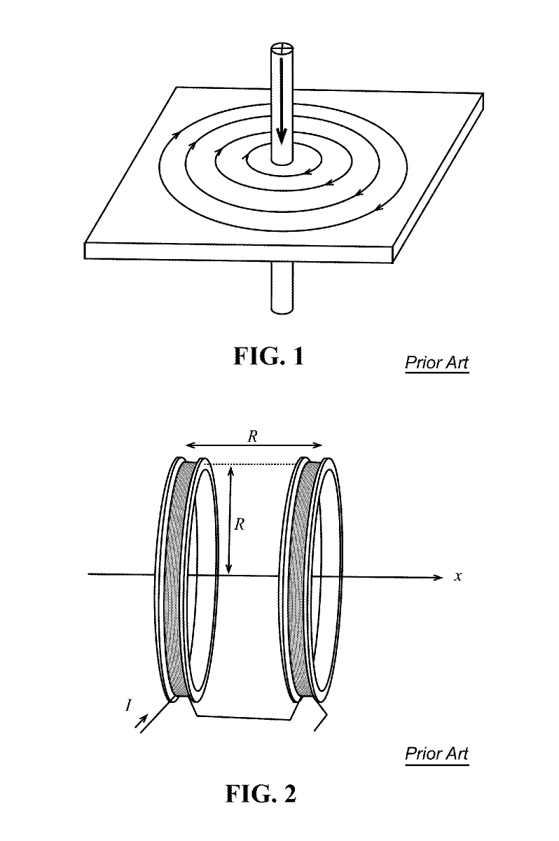

Consider a wire with a current running through it, as shown in FIG. 1. The current in the wire creates a magnetic field. At every point in space, the field has two characteristics, a direction and a magnitude. The magnitude decays with distance from the wire. Meanwhile, the direction of the field is tangent to a circle aligned on the same axis as the wire.

A current carrying wire wrapped into a ring will create a large magnetic field at the center of the ring, where the field contributions from each segment of the wire add. The most common way to create a magnetic trap is to align two coils of wire along the same axis with the currents running opposite to each other, a so-called Helmholtz Configuration as shown in FIG. 2. The combined fields will cancel at the midpoint between the coils. The field magnitude is zero and increases in all directions from that point.

### Creating a Magnetic Trap on a Chip

A free-space magnetic trap is inefficient. Energy is used to create a magnetic field everywhere between the large, macroscopic wire coils, while the trap only uses the field at the direct center. The energy budget is significantly reduced, and fabrication greatly simplified, by creating magnetic traps above the surface of planar chips with current-carrying wires.

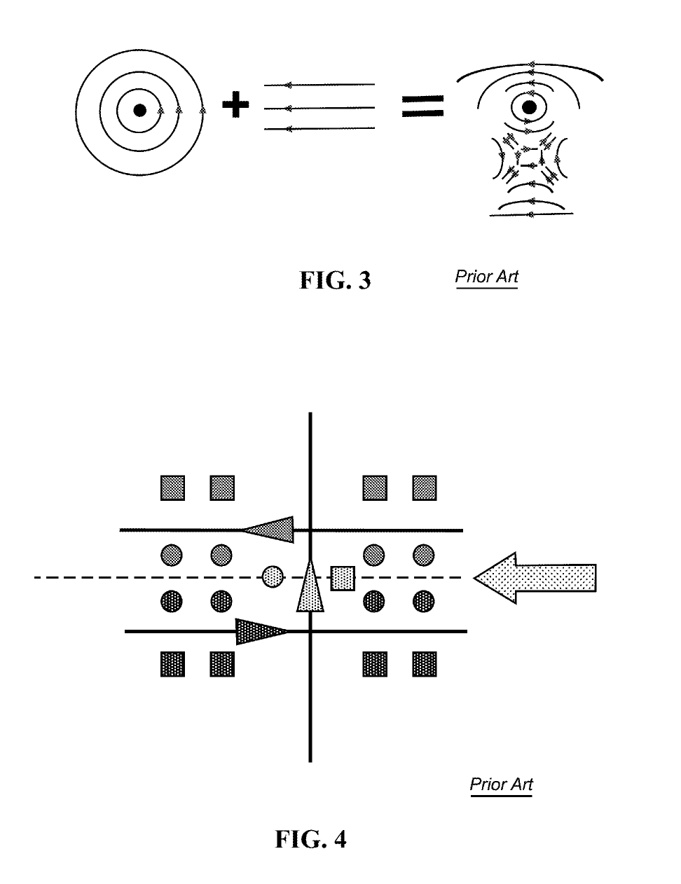

Imagine that we introduce a constant magnetic field with a direction perpendicular to the wire shown in FIG. 1. At some distance from the wire, the new “bias” field will completely cancel the field from the wire. As shown in FIG. 3, the resulting magnetic field circulates around a point where the field magnitude is zero. Note that FIG. 3 is viewed along the wire axis, with the wire going into the page, so the field is zero along a line running parallel to the wire and into the page.

If we wanted to make a trap in all three directions, we could add two wires to create the shape of a sideways “H”, as shown in FIG. 4. Circles XX represent a magnetic field XX coming out of the page, and squares XX represent a magnetic field going into the page. Two new wires XX and XX act as end caps to the two-dimensional trap created in FIG. 3.

Wires XX and XX are symmetric about a central axis XX. Thus, along central axis XX the components of their fields parallel to wire XX cancel while their components pointing out of the page add. A zero magnetic field will occur at a height where the out of the page components from wires XX and XX cancel with the into the page components of wire XX, and at the horizontal position where the horizontal component of wire XX cancels with bias field XX.

The state of the art with respect to atom chips is usually a variation of one of two chip traps. The first, a “U-wire” trap, bends a single wire into the shape of a “U.” The analysis proceeds identically to that done for the “H” configuration in FIG. 4. As in the “H” setup, the “U-wire” has a minimum where the magnetic field is zero.

In many experiments, the magnetic field cannot be zero. In that case, a “Z-wire” trap is used, where a wire is bent to the side and then forward again.

### Bias Free Trapping and Control

The described prior art chip-based designs all make use of a bias field to create their magnetic traps. While effective, these externally imposed bias fields are usually produced with large external coils, similar to those in FIG. 2. Accordingly, use of a bias field runs contrary to the energy efficiency goals that motivating the use of chips in the first place.

Additionally, the eventual goal of chip based cold atom technology is to incorporate many elements onto a cohesive structure, an “integrated” atom chip. If one element requires a bias field while another does not, or requires a different bias, then the resulting integrated chip could not run multiple elements simultaneously.

### First Version

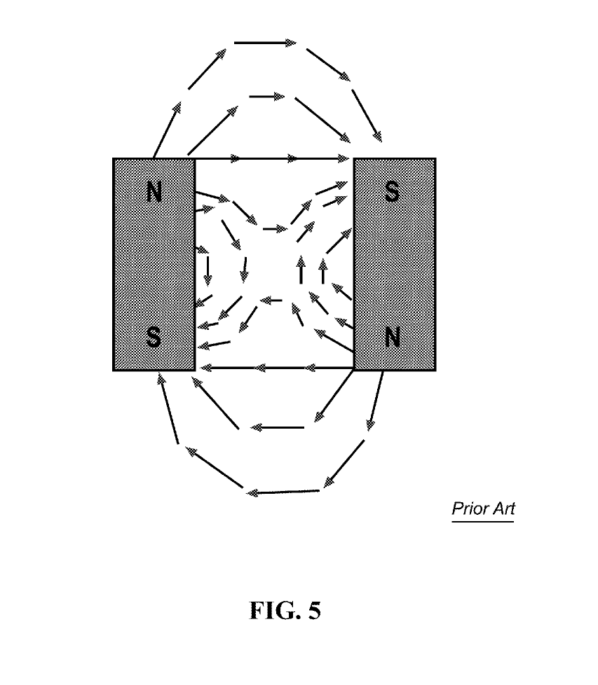

The first version or variation of the present invention will be better understood from first reviewing a conventional magnetic field XX created between a pair of permanent magnets XX and XX as shown in FIG. 5.

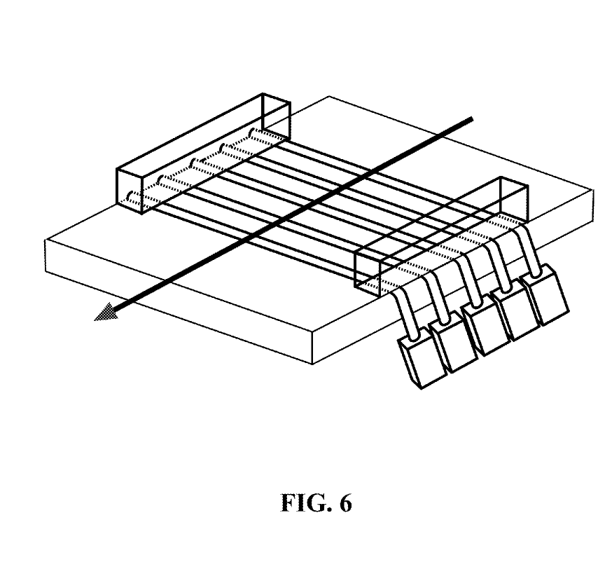

FIG. 6 shows a pair of permanent magnets XX and XX, similar to magnets XX and XX, mounted onto a chip segment XX. A large number of current carrying wires, or conductors, XX are mounted in chip segment XX below magnets XX and XX. Only five wires XX are shown in this view for clarity. A much larger number of wires would be used for an actual chip scale apparatus. Each wire XX is connected to a separate electronic circuit for supplying a current to each of wires XX.

A beam of neutral atoms, or molecules, XX passes between magnets XX and XX and above wires XX. Circuits XX are timed to sequentially supply a current to each wire XX to produce a moving magnetic field that interacts with the magnetic field produced by magnets XX and XX to create a moving magnetic trap to slow, and control, the atoms in beam XX.

The advantage of this configuration compared to the prior art is its compact size and efficiency by establishing and controlling a magnetic field primarily only along the path of beam XX.

A difficulty with this version is separately controlling the sequential timing of the currents delivered to wires XX.

### Second Version

The second version for the present invention also creates a magnetic trap without an imposed bias field, and also similarly efficiently establishes a field primarily only along the path of a beam of neutral atoms. More advantageously, it does so by controlling only two current carrying wires without the precise and difficult, timing requirements of the first version. It will be able to move cold atoms between elements on a chip similar to a conveyor belt. Further, it could be used to slow, capture and collect atoms from a hot atomic beam.

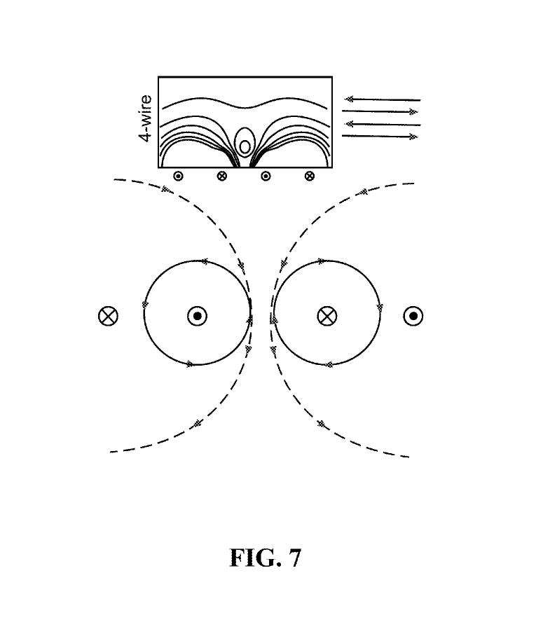

The invention starts with a known way to guide atoms on a chip, a four-wire waveguide XX as shown in FIG. 7. Usually, a four-wire waveguide uses a bias field XX and four parallel wires XX carrying currents in alternating directions. A two-dimensional magnetic trap forms above wires XX along a central axis XX parallel to the wires. A beam of atoms would be confined to travel or be “guided” between wires XX.

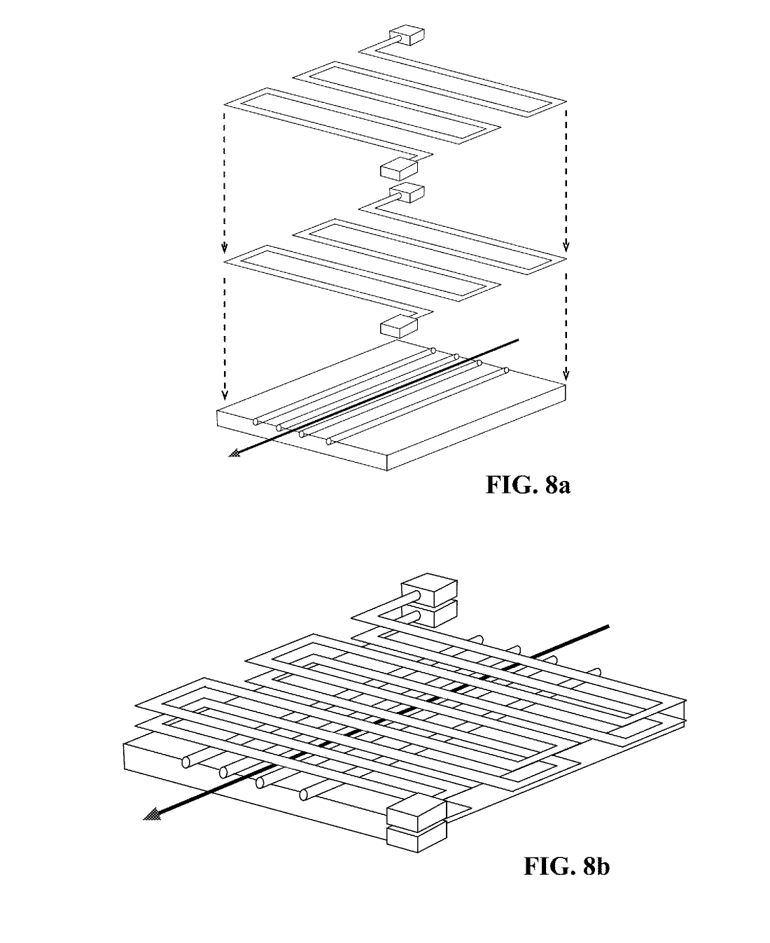

FIG. 8a is an exploded, and FIG. 8b a less exploded, schematic perspective view of an example embodiment of the second version according to the teachings of the present invention showing a pair of back and forth first and second current carrying wires, or conductors, XX and XX above a four-wire waveguide XX set into the surface of a chip XX. A beam of neutral atoms, or molecules, passes just above four-wire waveguide XX.

At a first spacing from waveguide XX, first wire XX crosses back and forth at regular intervals perpendicular to waveguide XX. At a second spacing from waveguide XX, at an interval offset, second wire XX crosses regularly across waveguide XX.

Using only waveguide XX and first back and forth wire XX, a periodic series of traps is created above chip segment XX. By varying the currents in both back and forth wires XX and XX, those traps can be moved down the waveguide. By varying the currents in waveguide XX, the traps can be moved up and down, and also into and out of the page. In other words, a complete three-dimensional control of the trap location is obtained, allowing use of the traps as a conveyor belt.

By using a series of counter-propagating currents for back and forth wires XX and XX, and for waveguide XX, the magnetic field decays quickly as a function of distance from the conveyor. Such decay means minimal impact on neighboring elements in and on an integrated chip.

By properly varying the currents of back and forth crossing wires XX and XX, the traps can decelerate along the length of waveguide XX. If a hot atomic beam is sent down the guide, these decelerating traps will slow the atoms in the beam. Once slowed, the traps can be combined and used for cold atom experiments. This type of slowing is called “Zeeman Deceleration” and is uniquely enabled by the teachings of the present invention.

The disclosed first and second versions can be combined by using a series of individually controlled crossing wires, similar to that described with reference to FIG. 6, instead of two crisscrossing back and forth wires. Then, by timing when the currents in these wires turn on and off, single moving traps with higher trap gradients can be created and utilized. Similar to as described for the FIG. 6 version, as each wire requires individual control, it can be difficult to implement.

Various other modifications to the invention as described may be made, as might occur to one with skill in the art of the invention, within the scope of the claims. Therefore, not all contemplated example embodiments have been shown in complete detail. Other embodiments may be developed without departing from the spirit of the invention or from the scope of the claims.

We claim:

1. A chip-scale apparatus for controlling a beam of neutral particles, comprising:
(a) a pair of permanent magnets defining a space between them for passage of the beam of neutral particles;
(b) a plurality of sequentially spaced conductors in a plane parallel to the beam of neutral particles, each conductor aligned perpendicularly to the beam of neutral particles; and,
(c) circuitry for sequentially applying currents to each conductor to create a moving magnetic field.

2. A method for controlling a beam of neutral atoms, comprising the steps of:
(a) providing a pair of permanent magnets, each permanent magnet on an opposite side of the beam of neutral particles;
(b) providing a plurality of parallel conductors in a plane parallel to the beam of neutral atoms, each conductor aligned perpendicularly to the beam of neutral particles; and,
(c) sequentially applying currents to each conductor to create a moving magnetic field, such that the shape of the field does not change over time.

3. A chip-scale apparatus for controlling a beam of neutral particles, comprising:
(a) a four-wire waveguide;
(b) a first back and forth current carrying conductor in a plane parallel to and at a first distance from the four-wire waveguide, defining a space between it and the four-wire waveguide for passage of the beam of neutral particles;
(c) a second back and forth current carrying conductor in a plane parallel to and at a second distance, greater than the first distance, from the four-wire waveguide; and,
(d) circuitry for applying currents to each conductor, wherein the current in the second back and forth current carrying conductor is out of phase with the current in the first back and forth conductor, such that a moving magnetic field will be created that will moves continuously along the waveguide.

4. A method for controlling a beam of neutral particles, comprising the steps
(a) providing a four-wire waveguide;
(b) providing a first back and forth current carrying conductor in a spaced relationship from the four-wire waveguide;
(c) providing a second back and forth current carrying conductor in a spaced relationship from the four-wire waveguide and the first back and forth current carrying conductor; and,
(d) wherein the current in the second back and forth current carrying conductor is out of phase with the current in the first back and forth conductor, such that the shape of the trap is conserved and moves continuously along the waveguide.
